(19) United States
(12) Patent Application Publication
(10) Pub. No.: US 2008/0148797 A1
(43) Pub. Date: Jun. 26, 2008

(54) Cold roll forming method for reducing a diameter of a metal pipe, and a metal pipe product having its diameter reduced by such method

(76) Inventors: Tsuyoshi Ishikawa, Aichi (JP); Yoshiya Tsukada, Aichi (JP); Ryoichi Suzuki, Aichi (JP); Akihiro Ishikawa, Tokyo (JP); Motoyoshi Ishikawa, Aichi (JP); Jun Ishikawa, Aichi (JP)

Correspondence Address: WENDEROTH, LIND & PONACK, L.L.P., 2033 K STREET N. W., SUITE 800, WASHINGTON, DC, 20006-1021, US

(21) Appl. No.: 12/003,386

(22) Filed: Dec. 21, 2007

Related U.S. Application Data
(63) Continuation of application No. 11/650,465, filed on Jan. 8, 2007, now abandoned.
Application No. 11/650,465 is a continuation of application No. 11/434,760, filed on May 17, 2006, now abandoned.
Application No. 11/434,760 is a continuation of application No. 10/381,341, filed on Mar. 25, 2003, now abandoned.

(30) Foreign Application Priority Data
Sep. 25, 2000 (JP) 2000-290861

(51) Int. Cl. B21B 13/08; F16L 9/00

(52) U.S. Cl. 72/234; 138/177

(57) ABSTRACT

A cold roll forming method for reducing a diameter of a metal pipe and a metal pipe product having a diameter reduced by such a method are disclosed, wherein the method includes: passing a raw metal pipe through a set of pre-forming rolls so that it can be pre-formed into an intermediate metal pipe having an elliptical, elongated circular or rectangular cross-sectional shape; and then passing the intermediate metal pipe through a set of diameter-reducing rolls disposed on a downstream side of the set of pre-forming rolls so that it can have its outer circumferential length reduced to be smaller than an outer peripheral length of the raw metal pipe, while at the same time being re-formed into a circular cross-sectional shape or any other cross-sectional shape different from the cross-sectional shape of the intermediate metal pipe.

This application is a continuation of U.S. application Ser. No. 11/650,465, which is a continuation of U.S. application Ser. No. 11/434,760, which is a continuation of U.S. application Ser. No. 10/381,341, which is the National Stage of International Application No. PCT/JP01/08310, filed Sep. 25, 2001.

### BACKGROUND

1. Technical Field

The present invention relates to a cold roll forming method for reducing a diameter of a metal pipe, and a metal pipe product having its diameter reduced by such method. More particularly, the present invention relates to a metal pipe so formed that its diameter can be reduced by the cold roll forming process.

2. Prior Art

There are a number of conventional cold roll forming methods, more specifically, cold diameter-reducing methods, whereby a diameter of a metal pipe may be reduced. These methods are briefly described below.

One method is provided for cold-reducing a steel pipe by using a 3-roll reducer (Japanese patent application as published under No. H7 (1995)-51707). This method is specifically designed to eliminate any possible irregular wall thickness that may occur on welded joints of the steel pipe. To this end, the method includes a reducing step in which a steel pipe may be reduced by passing it through three or more reducer stands, and a sizing step in which a steel member resulting from the reducing step may be sized by passing it through a two-roll sizing device on two or more roll stands.

Another method uses a die that has a particular pattern formed around an inner circumferential surface thereof, through which a steel pipe may be passed and drawn so that the steel pipe can have a pattern of alternating grooves and ridges formed like a twill weave running along a length thereof (Japanese patent application as published under No. H7 (1995)-314031). More specifically, a die that has a gear-like pattern on the inner circumferential surface thereof is combined with a plug designed to reduce a wall thickness of a raw steel pipe. A finished steel pipe may thus be provided by applying a strong compressive force against the wall thickness of the steel pipe, thereby causing the wall thickness to be deformed under this applied compressive force.

A further method is designed for cold roll forming an electro-resistance-welded steel pipe. A final-stage roll stand that is located on an extreme downstream side includes a set of rolls having a particular roll profile, with a bore formed by the set of rolls being rounded to conform to the roll profile (Japanese patent application as published under No. H6 (1996)-142718).

The above mentioned methods may serve their respective cold-working or cold-roll-forming purposes, but any of the methods has problems in that a machine that is used to implement this method is designed for particular applications, there are restrictions on size (angle) of a steel pipe that can be cold-worked or rolled, a number of roll stands must be increased, and the like.

### SUMMARY OF THE INVENTION

It is therefore one object of the present invention to provide a cold-working method, more specifically, a cold roll forming method, that provides an easy and reliable manner for cold roll forming raw metal pipes by using sets of diameter-reducing rolls, without having to increase a number of roll stands used, wherein the method may be used to roll a raw metal pipe so that it can have a reduction in terms of its diameter, or to roll the raw metal pipe so that it can have a pattern of alternating grooves and ridges on inner and/or outer circumferential surface(s) thereof while at the same time having reduction in terms of its diameter, or to roll a double pipe including an outer pipe and an inner pipe so that it can have a reduction in terms of its diameter.

Another object of the present invention relates to a metal pipe product that has its diameter reduced by using such method.

The present invention solves the problems associated with the prior art methods described above, by providing a cold roll forming method that includes a pre-forming step of pre-forming a raw metal pipe into an intermediate metal pipe by passing it through a set of pre-forming rolls, followed by a diameter-reducing step of reducing a diameter of the intermediate metal pipe by passing it through a set of diameter-reducing rolls arranged in tandem with the set of pre-forming rolls.

More specifically, the cold roll forming method according to the present invention solves the above problems by allowing a raw metal pipe to be passed through a set of pre-forming rolls so that it can be formed into an intermediate metal pipe having any of an elliptic, elongated circular, rectangular and polygonal cross sectional shape, and then allowing the intermediate metal pipe to be passed through a set of diameter-reducing rolls located downstream of the set of pre-forming rolls so that it can be re-formed into a final metal pipe having a circular cross section or any other cross-sectional shape that is different from the cross-sectional shape of the intermediate metal pipe, thereby producing a final metal pipe having its outer circumferential length reduced to a smaller length than an outer circumferential length of the raw metal pipe.

It may be understood from the above description that in the cold roll forming method according to the present invention, a diameter-reducing process may be performed by passing a raw metal pipe through a set of pre-forming rolls so that it can be pre-formed into an intermediate metal pipe having a particular cross-sectional shape, and then passing the intermediate metal pipe through a set of diameter-reducing rolls arranged in tandem with the set of pre-forming rolls so that it can be formed into a final metal pipe having a reduction in terms of its diameter. In this method, a pre-forming step may occur in a single pass, and a diameter-reducing step that follows the pre-forming step may also occur in a single pass. Alternatively, other methods are possible, depending upon a particular type of material on which a raw metal pipe is based, a particular wall thickness required for the raw metal pipe, a particular diameter reduction rate required for the raw metal pipe, particular usage of a finished metal pipe, and other particular requirements. Some of these other methods are described below.

For example, a process according to one possible method may include multiple pre-forming steps that correspond to multiple sets of pre-forming rolls, and multiple diameter-reducing steps that correspond to multiple sets of diameter-reducing rolls, wherein these sets of pre-forming rolls and these sets of diameter-reducing rolls are arranged in tandem such that each set of pre-forming rolls is followed by each set of diameter-reducing rolls. This process allows for multiple passes of a raw metal pipe through each succeeding combination of one set of pre-forming rolls and one set of diameter-reducing rolls.

A process according to another possible method may include a single pre-forming step that corresponds to a single set of pre-forming rolls or multiple pre-forming steps that correspond to multiple sets of pre-forming rolls arranged in tandem with each other, and a single diameter-reducing step that corresponds to a single set of diameter-reducing rolls or multiple diameter-reducing steps that correspond to multiple sets of diameter-reducing rolls arranged in tandem with each other. This process allows for a single pass or multiple passes of a raw metal pipe through the single or multiple sets of pre-forming rolls, and allows for a single pass or multiple passes of a resulting metal pipe through the single or multiple sets of diameter-reducing rolls.

Any of the methods described above allows for use of a raw metal pipe that has any cross-sectional shape, such as circular, elliptical, elongated circular, rectangular, triangular, pentagonal, hexagonal, and other polygonal shapes.

According to the methods described above, a raw metal pipe that has any of the above-mentioned cross-sectional shapes may be pre-formed into any different cross-sectional shape other than an original cross-sectional shape of the raw metal pipe. For example, when the raw metal pipe has a circular cross-sectional shape, it may be pre-formed into any of an elliptical, elongated circular, rectangular and polygonal cross-sectional shape. Similarly, when the raw metal pipe has any of an elliptical, elongated circular, rectangular and polygonal cross-sectional shape, it may be pre-formed into a circular cross-sectional shape. As another example, when the raw metal pipe has a square or rectangular cross-sectional shape, it may be pre-formed into a rectangular or square cross-sectional shape, respectively. As a further example, when the raw metal pipe has an elliptical, elongated circular, rectangular or polygonal cross-sectional shape, it may be pre-formed into an elliptical, elongated circular, rectangular or polygonal cross-sectional shape, in which case any of these cross-sectional shapes may be provided by moving and rotating the raw metal pipe in its circumferential direction. It should be noted, however, that when the raw metal pipe having the circular cross section is pre-formed into the same cross-sectional shape, it is difficult to reduce a diameter of such pre-formed metal pipe at a diameter-reduction rate of more than 3% when it is passed through a subsequent set of diameter-reducing rolls. In such case, it is desirable that the raw metal pipe having the circular cross section should be pre-formed into any of an elliptical, elongated circular, rectangular, triangular, pentagonal, hexagonal or any other polygonal cross-sectional shape.

A raw metal pipe may be pre-formed into any of the cross-sectional shapes shown above, by using an appropriate number of rolls in each set of pre-forming rolls, or by providing such rolls that have an appropriate cross-sectional shape, or by combining such multiple sets of pre-forming rolls arranged in tandem. For example, when a raw metal pipe is to be pre-formed into a rectangular cross-sectional shape on one roll stand, the roll stand may include two such pre-forming rolls 2a, 2b as shown in FIG. 1 (a), or four such pre-forming rolls 2a, 2b, 2c, 2d as shown in FIG. 1 (b). Generally, when a raw metal pipe is pre-formed into an elliptical or elongated circular cross-sectional shape on one roll stand, the roll stand may include two pre-forming rolls as shown in FIG. 1 (a), and when a raw metal pipe is pre-formed into any polygonal cross-sectional shape such as triangular on one roll stand, the roll stand may include two or three pre-forming rolls. Furthermore, when a raw metal pipe is pre-formed into any polygonal cross-sectional shape such as pentagonal on one roll stand, the roll stand may include four or five pre-forming rolls. In addition, when a raw metal pipe is pre-formed into any polygonal cross-sectional shape such as hexagonal on one roll stand, the roll stand may include four or six pre-forming rolls.

In accordance with the cold roll forming methods of the present invention that have been described so far, a final metal pipe having its outer circumferential length reduced to be smaller than an outer circumferential length of a raw metal pipe has any particular cross-sectional shape such as circular, elliptical, elongated circular, rectangular and polygonal cross-sectional shapes. This may be accomplished by using an appropriate number of rolls in each set of diameter-reducing rolls, or by providing such rolls that have an appropriate cross-sectional shape, or combining such multiple sets of diameter-reducing rolls arranged in tandem.

A metal pipe that has been pre-formed into any particular cross-sectional shape through the set of pre-forming rolls may have its diameter reduced over its total length by passing this pre-formed metal pipe through the set of diameter-reducing rolls. Alternatively, some part of a raw metal pipe may be pre-formed into any particular cross-sectional shape through the set of pre-forming rolls, and then diameter-reducing rolling is performed by the diameter-reducing rolls on this pre-formed part, whereby a final metal pipe in which some part of it is reduced in its outer circumferential direction is obtained.

Each of the rolls in the set of diameter-reducing rolls may have a particular pattern of grooves and ridges on a circumferential surface thereof. By passing a metal pipe pre-formed by a preceding set of pre-forming rolls through a following set of diameter-reducing rolls, the metal pipe may have a pattern of ridges and grooves formed on a surface while at the same time having its diameter reduced, when it is passed through the set of diameter-reducing rolls having the before described particular pattern.

In this case, the cold roll forming methods of the present invention allow a final metal pipe to have a pattern of ridges and grooves formed on an outer circumferential surface according to the pattern provided on the diameter-reducing rolls by causing an outer circumferential surface of a pre-formed metal pipe to engage the surface of the diameter-reducing rolls, while allowing the final metal pipe to have its diameter reduced by the diameter-reducing rolls. One complete revolution of the diameter-reducing rolls corresponds to one pitch of the pattern being formed on the outer circumferential surface of the final metal pipe.

In the prior art cold roll forming method mentioned earlier wherein a metal pipe can have a pattern formed thereon by drawing it through a die, the metal pipe can only have the pattern formed in its longitudinal direction. In contrast to the prior art method, the method according to the present invention allows a metal pipe to have a pattern formed on a surface such that the pattern can be changed periodically for every pitch of the diameter-reducing rolls.

For example, when rolls in a set of diameter-reducing rolls have a pattern of ridges and grooves on respective surfaces thereof that are running in a direction in which the rolls rotate, a final metal pipe having its diameter reduced may have the same pattern of alternating grooves and ridges on a surface thereof that are running in a longitudinal direction of the metal pipe, or running in straight lines parallel with a central axis of the metal pipe, when it is passed through the set of diameter-reducing rolls. The pattern of alternating grooves and ridges on the diameter-reducing rolls may be modified to different patterns, such as a pattern of alternating grooves and ridges that appear as oblique lines inclined at an angle with regard to the central axis of the metal pipe, a pattern of alternating grooves and ridges that appear as arc lines, a pattern of alternating grooves and ridges that appear as spiral lines, and any other desired pattern of alternating grooves and ridges.

In the cold roll forming methods of the present invention described so far, a pattern molding die may be provided in a bore formed by a set of diameter-reducing rolls. This pattern molding die has a pattern of ridges and grooves on an outer circumferential surface thereof, and can be inserted into a pre-formed metal pipe. Thus, when this metal pipe passes through the bore formed by the diameter-reducing rolls, it may have the same pattern of ridges and grooves, formed by the pattern molding die, on an inner circumferential surface of the metal pipe while at the same time having its diameter reduced by the set of diameter-reducing rolls.

A raw metal pipe that will be pre-formed and then have its diameter reduced according to a method of the present invention has a given length (on the order of 0.5 m to 10 m, for example). The pattern molding die may be supported by any supporting member that may be provided to extend along a traveling course of the metal pipe from a downstream side toward an upstream side, or from the upstream side toward the downstream side. In this way, the pattern molding die can be inserted into the metal pipe as the metal pipe passes through the bore formed by the diameter-reducing rolls. Thus, when the pattern molding die, that has a particular pattern of ridges and grooves on the outer circumferential surface thereof, is provided in the bore formed by the diameter-reducing rolls, the metal pipe may have that particular pattern formed on an inner circumferential surface thereof while at the same time having its diameter reduced by the diameter-reducing rolls, as it passes through the diameter-reducing rolls.

For example, the metal pipe may have the pattern of ridges and grooves formed on the inner circumferential surface thereof such that the ridges and grooves can appear as straight lines parallel with a central axis of the metal pipe, when the metal pipe passes through the set of diameter-reducing rolls. A supporting member that supports the pattern molding die may be provided so that it can be moved forward or backward in a traveling direction of the metal pipe. In this way, the pattern can be formed on any desired portion of the inner circumferential surface of the metal pipe while at the same the pipe has its diameter reduced by the set of diameter-reducing rolls.

The pattern molding die having the particular pattern on its outer surface, coupled with the set of diameter-reducing rolls having the particular pattern on its outer surface, may provide respective patterns on inner and outer circumferential surfaces of a metal pipe as it passes through the set of diameter-reducing rolls.

The pattern molding die may be provided in the form of a roll, plug or the like, and a particular pattern of ridges and grooves may be provided on its outer circumferential surface.

Now, an embodiment of the cold roll forming method according to the present invention that is specifically designed for use in working a double pipe is described. In order to solve the problems mentioned above in the “Prior Art” section, this cold roll forming method allows for working of a double pipe including an inner pipe having a smaller diameter and an outer metal pipe having a larger diameter, with the inner pipe being inserted into the outer metal pipe. Specifically, the cold roll forming method includes a pre-forming step that corresponds to a set of pre-forming rolls and a diameter-reducing step that corresponds to a set of diameter-reducing rolls, wherein this raw double pipe may be passed through the set of pre-forming rolls so that its outer metal pipe can be pre-formed into any of an elliptical, elongated circular, rectangular and polygonal cross-sectional shape, and then this pre-formed double pipe may be passed through the set of diameter-reducing rolls so that its outer metal pipe can be re-formed into a circular cross-sectional shape or any other cross-sectional shape different from a pre-formed cross-sectional shape of the outer metal pipe, while at the same time at least a diameter of the outer metal pipe is reduced by the set of diameter-reducing rolls. In this double pipe thus finished, the inner and outer pipes are united by causing part or all of an inner circumferential surface of the outer pipe to engage an outer circumferential surface of the inner pipe tightly.

It may be appreciated that this method provides an easy manner for manufacturing such double pipe products.

For example, a double pipe that may be cold-worked by this method may include an inner pipe having a triangular cross-sectional shape and an outer pipe having a circular cross-sectional shape.

When such double pipe is passed through the set of diameter-reducing rolls, it may be re-formed such that an inner circumferential length of the outer pipe can become smaller than an outer circumferential length of the inner pipe, thereby causing an inner circumferential surface of the outer pipe to engage an outer circumferential surface of the inner pipe tightly. In this double pipe thus finished, the inner pipe and outer pipe may have respective outer circumferential surfaces and inner circumferential surfaces that engage each other tightly under applied uniform and equal pressure, and with a uniform thermal property. This final double pipe product thus obtained may provide highly improved reliability.

In a process during which a double pipe is worked as described above, the double pipe is passed through one set of pre-forming rolls, and then through one set of diameter-reducing rolls arranged in tandem with the set of pre-forming rolls. That is, a single pass occurs through the set of pre-forming rolls, and then a single pass occurs through the set of diameter-reducing rolls. Alternatively, other methods are possible, depending upon a particular type of material on which each of the inner and outer pipes is based, a particular wall thickness required for each, a particular diameter reduction rate required for each, a particular usage of a finished double pipe, and other particular requirements. Some these other methods are described below.

For example, a process according to one possible method may include multiple pre-forming steps that correspond to multiple sets of pre-forming rolls, and multiple diameter-reducing steps that correspond to multiple sets of diameter-reducing rolls, wherein each combination consisting of each set of pre-forming rolls and each following set of diameter-reducing rolls is arranged in tandem with each following combination so that a double pipe can pass through each succeeding combination. This process allows for multiple passes of the double pipe through each succeeding combination of one set of pre-forming rolls and one set of diameter-reducing rolls.

A process according to another possible method may include a single pre-forming step that corresponds to a single set of pre-forming rolls or multiple pre-forming steps that correspond to multiple sets of pre-forming rolls arranged in tandem with each other, and a single diameter-reducing step that corresponds to a single set of diameter-reducing rolls or multiple diameter-reducing steps that correspond to multiple sets of diameter-reducing rolls arranged in tandem with each other. This process allows for a single pass or multiple passes of a double pipe through the single or multiple sets of pre-forming rolls, and allows for a single pass or multiple passes of a resulting double pipe through the single or multiple sets of diameter-reducing rolls.

Like the methods described earlier in connection with a single metal pipe, any of the methods just described above allows for use of a raw double pipe including an inner pipe and an outer pipe, each of which has any of cross-sectional shape, such as circular, elliptical, elongated circular, rectangular, triangular, pentagonal, hexagonal, and other polygonal shapes. Each of inner and outer pipes that have any of the above-mentioned cross-sectional shapes may be pre-formed into any cross-sectional shape other than circular, elliptical, elongated circular, rectangular, triangular, pentagonal, hexagonal, and other polygonal shapes.

According to the cold roll forming methods that are used for manufacturing a double pipe, inner and outer pipes can be united without using any bonding media. Thus, a double pipe thus obtained can provide highly improved reliability.

When a double pipe is to be formed according to any of the above cold roll forming methods, an inner pipe may be inserted into an outer pipe at any part or along a total length of the outer pipe.

When the inner pipe is inserted into the outer pipe along the total length of the outer pipe, this double pipe that is passed through the set of pre-forming rolls and then through the set of diameter-reducing rolls includes inner and outer pipes that overlap each other over the total length thereof. When the inner pipe is inserted into the outer pipe at a desired part of the total length of the outer pipe, this double pipe that is passed through the set of pre-forming rolls and then through the set of diameter-reducing rolls includes inner and outer pipes that overlap each other at the desired part of the total length of the outer pipe. Thus, a wall thickness at an area of the double pipe where the inner and outer pipes overlap each other can become greater than a remainder of the double pipe.

The inner pipe may be made of any metal. In this case, the metal may be the same as, or different from, a metal usually used for the outer pipe. Alternatively, the inner pipe may be made of any non-metal material. In this case, the outer pipe may be made of steel, and the inner pipe may be made of aluminum, titanium, or synthetic resin.

In any of the above cases, after a double pipe including inner and outer pipes is obtained by passing it through a set of pre-forming rolls and then through a set of diameter-reducing rolls, this double pipe may be used as an inner pipe, and may be inserted into another metal pipe of a greater diameter. This triple pipe thus obtained may then be passed through the set of pre-forming rolls and then through the set of diameter-reducing rolls. Other multiple-layer pipes such as a quartet pipe, quintet pipe and the like may be obtained in the same manner.

When a double pipe is manufactured by using an appropriate cold roll forming method of the present invention described above, it may be readily appreciated that the double pipe may be finished by passing it through a set of pre-forming rolls and then through a set of diameter-reducing rolls. Thus, what is required during a preliminary stage prior to a production stage is only to clean inner and outer pipes. In other words, the inner and outer pipes need not be subjected to any thermal treatment or special machining prior to the production stage.

For the same reasons, the rolls should not be made of special roll materials, but may be made of any roll material. The rolls need not be subjected to any surface treatment. Thus, the double pipe may be finished at less cost and more efficiently.

When a double pipe is pre-formed into any of an elliptical, elongated circular, rectangular, or polygonal cross-sectional shape during a pre-forming process in the cold roll forming method, the pre-forming process may occur, with at least part of an inner circumferential surface of an outer metal pipe engaging an outer circumferential surface of an inner pipe. When a diameter-reducing process that follows the pre-forming process then occurs with the inner pipe being secured in position, it may occur without causing the inner pipe to be misaligned with regard to the outer pipe. When the diameter-reducing process then occurs with part of the inner pipe being inserted into the outer pipe, only portions of the inner and outer pipes overlapping each other can have increased wall thickness, and this can be performed accurately.

Each of the diameter-reducing rolls that are used for the above purposes may also have a particular pattern of ridges and grooves thereon. Then, a double pipe that has been pre-formed through the set of pre-forming rolls may have the particular pattern of ridges and grooves formed thereon while having its diameter reduced, as the double pipe is passed through the set of the diameter-reducing rolls. A double pipe product that has thus been finished includes an outer metal pipe having the above pattern formed on an outer circumferential surface thereof.

When a raw metal pipe is worked by using any of the cold roll forming methods of the present invention, an arrangement including sets of pre-forming rolls and sets of diameter-reducing rolls, or a raw metal pipe being worked, may be moved relative to the other in an axial direction of the raw metal pipe.

When the raw metal pipe is to be moved relative to the arrangement of the pre-forming rolls and diameter-reducing rolls, this may be accomplished by arranging the sets of pre-forming rolls and the sets of diameter-reducing rolls as follows.

For example, the arrangement may include several sets of pre-forming rolls and several sets of diameter-reducing rolls, wherein some or all of the rolls in each set of the pre-forming rolls and each set of diameter-reducing rolls may be linked operatively so that each of these rolls can be rotated. This allows a moving raw metal pipe to pass through each set of pre-forming rolls and then through each set diameter-reducing rolls.

One example of this arrangement is shown in FIG. 5 (c), which is called a roll forming system (roll driving system). An example of the arrangement shown in FIG. 5 (c) includes sets of pre-forming rolls 41a, 41b, 41c, and sets of diameter-reducing rolls 42a, 42b, 42c. As seen from FIG. 5 (c), the sets of pre-forming rolls and the sets of diameter-reducing rolls are arranged in tandem, and one set of pre-forming rolls is followed by one set of diameter-reducing rolls, which is followed by another set of pre-forming rolls which is followed by another set of diameter-reducing rolls, and so on. In this arrangement, a raw metal pipe may be moved so that it can pass through each succeeding combination of the sets of pre-forming rolls and diameter-reducing rolls for a total of three times. When the sets of pre-forming rolls and the sets of diameter-reducing rolls are arranged in tandem, a particular set of pre-forming rolls or diameter-reducing rolls may be driven. For example, if one set includes four rolls, two rolls in the set may be driven. In the example shown in FIG. 5 (c), the set of diameter-reducing rolls 42c includes four rolls, of which only two upper and lower rolls 2a, 2c are driven, with remaining two side rolls 2b, 2d (not shown) being idler rolls.

In an alternative arrangement in which one set of pre-forming rolls and one set of diameter-reducing rolls include a plurality of rolls, respectively, and some or all of the rolls in respective sets of pre-forming rolls and diameter-reducing rolls are idler rolls that are not driven by any external drive source, a raw metal pipe may be passed through these sets of pre-forming rolls and diameter-reducing rolls in any of the following ways.

One way is to push a raw metal pipe forward into the set of pre-forming rolls, and into the set of diameter-reducing rolls by use of any pushing device. Specifically, the raw metal pipe may first be pushed into a bore formed by the set of pre-forming rolls located on an upstream side, and then may be pushed into a bore formed by the set of diameter-reducing rolls located on a downstream side of the set of pre-forming rolls. An example of this method is shown in FIG. 5 (a), which is called an extroll-forming system (which may also be called a non-driven roll pipe pushing system). Examples of a pushing device that may be used for this purpose include a hydraulically-operated cylinder, a hydraulically-operated jack and the like.

Another way is to draw a raw metal pipe out through the set of pre-forming rolls, and through the set of diameter-reducing rolls toward the downstream side by use of a drawing device. Specifically, the raw metal pipe may first be drawn out through the bore formed by the set of pre-forming rolls and then through the bore formed by the set of diameter-reducing rolls. One example of this system is shown in FIG. 5 (b), which is called a draw bench system (which may also be called a non-driven roll pipe drawing system). Examples of the drawing device that may be used for this purpose include a combination of a chuck that is operated to catch a forward tip of a metal pipe and a hydraulically-operated jack that holds the chuck and pulls it by traction force, or a combination of such chuck and a chain that is driven to rotate circularly for moving the chuck by traction force.

Still another way is a combination of the two systems described above, wherein a raw metal pipe may be moved by the pushing device on the upstream side so that it can be pushed through the bore formed by the set of pre-forming rolls and through the bore formed by the set of diameter-reducing rolls, while the metal pipe is also pulled by the drawing device on the downstream side so that it can be drawn out through the bore formed by the set of pre-forming rolls and through the bore formed by the set of diameter-reducing rolls.

Which of the three systems described above should be chosen may be determined, based on various factors, such as diameter, wall thickness, length, and rate of movement of a raw metal pipe being worked.

When any of these systems is chosen, the following considerations are required. For the extroll-forming system, the hydraulically-operated cylinder tends to be lengthy, so it would be necessary to ensure that the cylinder is not longer. For the draw bench system, it would be necessary to ensure that no deformation occurs on an end of a metal pipe being pulled. Finally, for the roll-forming system, it would be necessary to select an appropriate roll driving method.

In each of the arrangements shown in FIG. 5 (a) and FIG. 5 (b), one set of pre-forming rolls 21 or 31 and one set of diameter-reducing rolls 22 or 32 are arranged in tandem, wherein a raw metal pipe may be passed through the set of pre-forming rolls one time, and then may be passed through the set of diameter-reducing rolls one time.

Other arrangements are possible, although they are not shown. As one example, one set of pre-forming rolls 21 may be provided on an upstream side, and several sets of diameter-reducing rolls 22 that are arranged in tandem may be provided on a downstream side of the set of pre-forming rolls 21. As another example, several sets of pre-forming rolls 21 may be arranged in tandem, and one set of diameter-reducing rolls 22 may be provided on a downstream side of the sets of pre-forming rolls. As a further example, several sets of pre-forming rolls 31 may be arranged in tandem, and several sets of diameter-reducing rolls 32 that are arranged in tandem may be provided on a downstream side of corresponding sets of pre-forming rolls.

As a variation of the arrangement shown in FIG. 5 (c), which is not shown, an arrangement may be such that it includes one set of pre-forming rolls 21a, followed by one set of diameter-reducing rolls 42a that is arranged in tandem with the set of pre-forming rolls. In this arrangement, one pass may occur through the set of pre-forming rolls, followed by one pass through the set of diameter-reducing rolls. As another variation, an arrangement may be such that it includes one set of pre-forming rolls 41a, followed by one set of diameter-reducing rolls 42a, or followed by several sets of diameter-reducing rolls 42a, 42b, 42c arranged in tandem. As a further variation, an arrangement may be such that it includes several sets of pre-forming rolls 41a, 41b, 41c arranged in tandem, followed by one set of diameter-reducing roll 42a, or followed by several sets of diameter-reducing rolls 42a, 42b, 42c arranged in tandem.

In any of these variations, a metal pipe that has been pre-formed by a set of preceding pre-forming rolls may be passed through a following set of diameter-reducing rolls without causing the metal pipe to be pinched out into a gap between rolls in the set of diameter-reducing rolls.

Any of these variations may also be applied to a double pipe, wherein the double pipe that has been pre-formed by a preceding set of pre-forming rolls may be passed through a following set of diameter-reducing rolls without causing an outer pipe to be pinched out into a gap between rolls in the set of diameter-reducing rolls.

According to the various cold roll forming methods that have been described so far, a diameter reduction rate of more than 3% may be attained each time that a metal pipe is passed through each succeeding combination of a set of pre-forming rolls and set of diameter-reducing rolls. Experiments that were conducted by the inventors of the present invention show that a diameter reduction rate of at most 22% can be attained for each pass of a metal pipe through each combination of the set of pre-forming rolls and set of diameter-reducing rolls. The diameter reduction rate may be varied in a range of between at least 3% and at most 22%, depending on respective types of pre-forming rolls and diameter-reducing rolls that are used.

For example, when a raw metal pipe is made of iron, and has a wall thickness of 1.6 mm and an outer diameter of 48.6 mm, a diameter reduction rate of 22% may be attained by passing the raw metal pipe through a pre-forming roll stand on which two pre-forming rolls are mounted so that it can be pre-formed into an intermediate metal pipe having a triangular cross-sectional shape, and then by passing the intermediate metal pipe through a diameter reduction stand on which three diameter-reducing rolls are mounted so that it can have its diameter reduced by compressing the metal pipe in a direction of compression with its triangle vertexes being directed inwardly. In another example, a set of two pre-forming rolls is used for the same metal pipe as in the previous example, but relative positions between the two rolls are changed and a set of diameter-reducing rolls is replaced by another set of diameter-reducing rolls. A diameter reduction rate that may be attained in this example is equal to 8%.

As a further example, when a raw metal pipe is made of iron, and has a wall thickness of 4.5 mm and an outer diameter of 216.3 mm, a diameter reduction rate of 11.8% may be attained by passing the raw metal pipe through a pre-forming roll stand on which two pre-forming rolls are mounted so that it can be pre-formed into an intermediate metal pipe having a rectangular cross-sectional shape, and then by passing the intermediate metal pipe through a diameter reduction stand on which four diameter-reducing rolls are mounted so that it can have its diameter reduced by compressing the metal pipe in a direction of compression with its rectangle vertexes being directed inwardly. In another example, a set of two pre-forming rolls is used for the same metal pipe as in the previous example, but relative positions between the two rolls are changed and a set of diameter-reducing rolls is replaced by another set of diameter-reducing rolls. A diameter reduction rate that may be attained in this example is equal to 5%.

As still another example, when a raw metal pipe is made of iron, and has a wall thickness of 4.5 mm and an outer diameter of 190.7 mm, a diameter reduction rate of 7.2% may be attained by passing the raw metal pipe through a pre-forming roll stand on which four pre-forming rolls are mounted so that it can be pre-formed into an intermediate metal pipe having a pentagonal cross-sectional shape, and then by passing the intermediate metal pipe through a diameter reduction stand on which five diameter-reducing rolls are mounted so that it can have its diameter reduced by compressing the metal pipe in a direction of compression with its pentagon vertexes being directed inwardly. In another example, a set of four pre-forming rolls is used for the same metal pipe as in the previous example, but relative positions between the four rolls are changed and a set of diameter-reducing rolls is replaced by another set of diameter-reducing rolls. A diameter reduction rate that may be attained in this example is equal to 3%.

When a double pipe is passed through each succeeding combination of a set of pre-forming rolls and a following set of diameter-reducing rolls arranged in tandem with the set of pre-forming sets, a diameter reduction rate for an outer pipe that may be attained ranges between 3% and 22% for each pass through each combination.

Metal pipes obtained by the cold roll forming methods described so far have been examined. Typically, when a raw metal pipe having a circular cross-sectional shape is pre-formed into an intermediate metal pipe having a circular cross-sectional shape, and then the intermediate metal pipe has reduction in terms of its diameter, results show that a final metal pipe has an outer diameter precision that is equivalent to or better than that of the raw metal pipe. After cutting the final metal pipe to examine its outer diameter, it is found that a cutting plane has an outer diameter that remains substantially the same as an original outer diameter of the final metal pipe.

Various embodiments of the cold roll forming method according to the present invention have been described, and various metal pipes according to the present invention that may be obtained by using these methods have also been described.

### BRIEF DESCRIPTION OF THE DRAWINGS

FIG. 1 (a) illustrates one example of a set of pre-forming rolls that may be used with the present invention, as viewed from a side thereof;

FIG. 1 (b) illustrates another example of a set of pre-forming rolls that may be used with the present invention, as viewed from a side thereof;

FIG. 2 (a) illustrates an example of a set of diameter-reducing rolls that may be used with the present invention, as viewed in cross section;

FIG. 2 (b) illustrates an example of a diameter reducing process including a set of pre-forming rolls, followed by a set of diameter-reducing rolls, as viewed from a side.

FIG. 3 (a) is a perspective view illustrating a metal pipe of the present invention;

FIG. 3 (b) is a perspective view illustrating another metal pipe of the present invention, with part of the metal pipe being broken away;

FIG. 4 illustrates an extroll-forming system, according to the embodiment of the present invention, that may be employed in conjunction with the method of the present invention, as viewed from a side;

FIG. 5 (a) illustrates the extroll-forming system, according to the embodiment of the present invention, that may be employed in conjunction with the method of the present invention, as viewed in perspective;

FIG. 5 (b) illustrates a draw bench system, according to the embodiment of the present invention, that may be employed in conjunction with the method of the present invention, as viewed in perspective; and

FIG. 5 (c) illustrates a roll-forming system, according to the embodiment of the present invention, that may be employed in conjunction with the method of the present invention.

### DETAILED DESCRIPTION OF THE PREFERRED EMBODIMENTS

Several preferred embodiments of the present invention will now be described in further detail by referring to the accompanying drawings. It should be understood that arrangements, shapes and relative positions of component elements or parts that are described below in connection with each of these embodiments are only shown by way of example, and are described in general terms so as to enable any person skilled in the art to understand underlying concepts and principles of the present invention. It should also be understood that specific values and compositions (materials) that are shown below for the component elements or parts are given for illustrative purposes. It may be appreciated by any person skilled in the art that the present invention is not limited to the embodiments that are provided in the following description, and therefore may be varied in many ways without departing from the spirit and scope of the present invention as defined in the appended claims.

### Embodiment 1

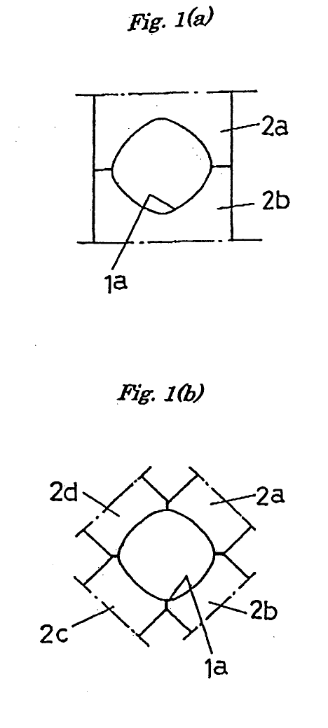

A raw pipe 1 that is subject to a diameter-reducing process is made of steel, and is originally formed into a round shape having an outer diameter of 216.3 mm. As an initial step, round steel pipe 1 may be passed through a set of pre-forming rolls 2a and 2b so that it can be formed into an intermediate steel pipe 1a having a rectangular cross section (FIG. 1 (a)).

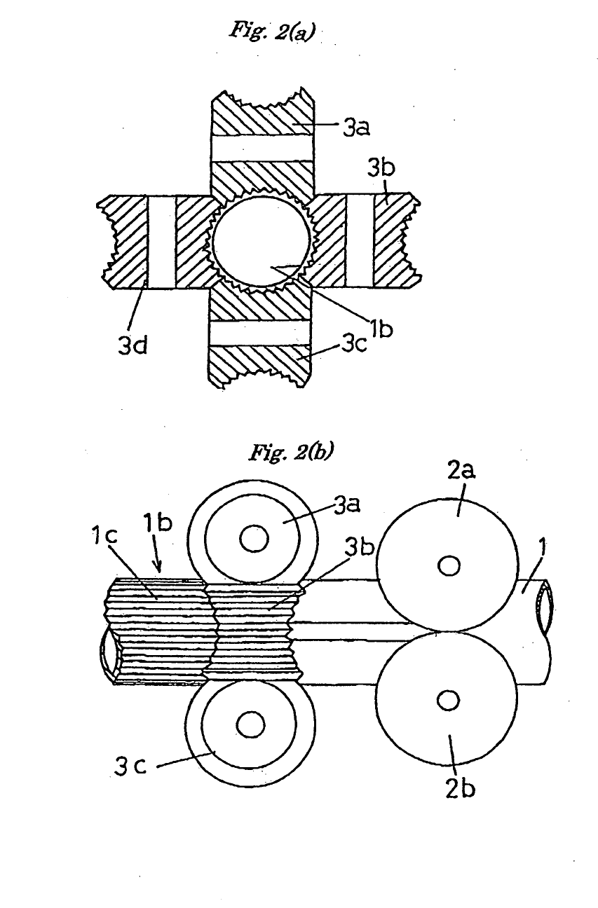

Then, the intermediate steel pipe 1a may be passed through a set of diameter-reducing rolls 3a, 3b, 3c and 3d so that it can be formed into a round steel pipe 1b having a reduced diameter (FIGS. 2 (a) and (b)).

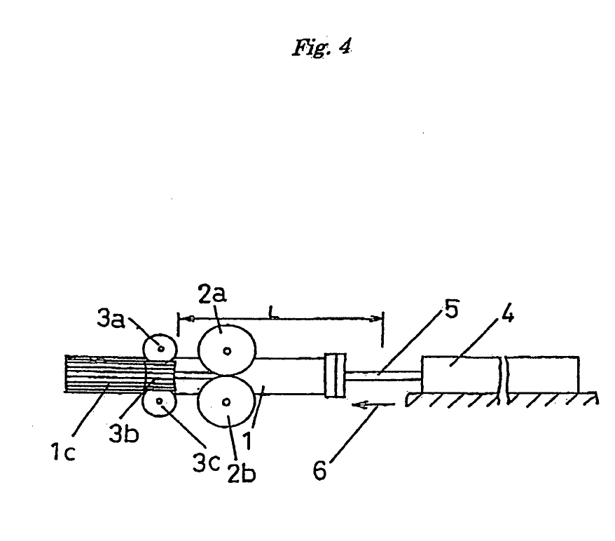

During the diameter-reducing process, a hydraulically-operated cylinder 4 may be operated so that its piston rod 5 can be moved forward in a direction of arrow 6 in FIG. 4, thereby moving the round steel pipe 1 in that direction. There are cases in which a size, particularly a length, of the hydraulically-operated cylinder 4 should be reduced into a particular size or length for some reasons. In those cases, a stroke L of the piston rod 5 that can travel to its full length might become shorter than a length of a particular round steel pipe 1 being processed. To avoid this, the piston rod 5 should preferably be provided with an auxiliary rod that may be interposed between the round steel pipe 1 and the piston rod 5. In this way, the stroke L of the piston rod 5 can be extended by a length of the auxiliary rod.

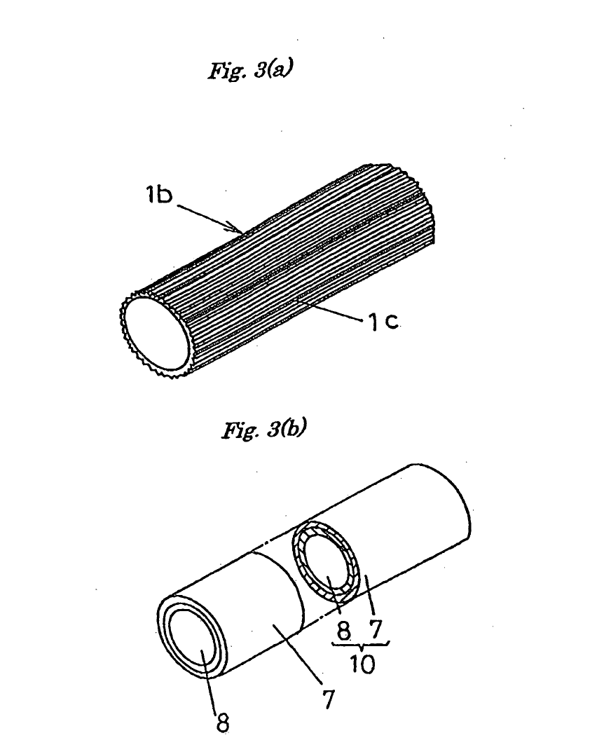

As shown in FIG. 2 (a), each of the rolls 3a, 3b, 3c, 3d in the set of diameter-reducing rolls has a particular pattern of alternating grooves and ridges formed around an outer circumferential surface thereof, running in a direction in which each roll rotates. When the intermediate steel pipe 1a is then passed through the set of diameter-reducing rolls, an output, which is represented by the round steel pipe 1b (FIG. 3 (a)), may have a reduction in terms of its diameter, while at the same time it may have the same pattern of ridges and grooves 1c, formed around the outer circumferential surface of the diameter-reducing rolls, running along a length of the round steel pipe 1b.

Specifically, raw round steel pipe 1 has the outer diameter of 216.3 mm and a wall thickness of 8.2 mm. When it is passed through the set of pre-forming rolls and then through the set of diameter-reducing rolls, round steel pipe 1b that is thus finished may have a reduced diameter of 190.7 mm and a pattern of sixty (60) alternating grooves and ridges 1c formed to a depth of 0.7 mm on its outer circumferential surface, running along its length. In this case, a finished steel pipe had its diameter reduced at a diameter reduction rate of 11.8%.

The set of pre-forming rolls 2a, 2b shown in FIG. 1 (a) may be replaced by another set of pre-forming rolls 2a, 2b, 2c, 2d shown in FIG. 1 (b).

In this case, a raw pipe is also made of steel, and has a round shape. It should be noted, however, that the raw pipe may also have any other cross sectional shape, and may also be made of any other material such as stainless steel, aluminum and the like.

### Embodiment 2

A raw pipe 7 is also made of steel, and has a round shape. Different from the preceding embodiment, the raw pipe 7 is a double pipe including an additional pipe 8 made of synthetic resin that is inserted into the raw steel pipe 7. A diameter reducing process includes a pre-forming step, followed by a diameter reducing step, like in the preceding embodiment, but differs in that each of rolls 3a, 3b, 3c, 3d in a set of diameter-reducing rolls has no pattern of ridges and grooves on its circumferential surface.

By passing the raw steel pipe 7 through the pre-forming step and then through the diameter reducing step, a double pipe 10 may be obtained, including the outer steel pipe 7 and the inner synthetic resin pipe 8 as shown in FIG. 3 (b).

Specifically, when the raw steel pipe 7 is passed through the diameter reducing step, it may have a reduction in terms of its diameter. In the double pipe 10 thus obtained, the outer steel pipe 7 and the inner synthetic resin pipe 8 can be united by causing an inner circumferential wall of the outer steel pipe 7 to engage an outer circumferential wall of the inner synthetic resin pipe 8 under uniform and equal pressure.

### Embodiment 3

A steel pipe “STKM13A” (carbon steel pipe for machine structural purposes) as specified in relevant JIS specifications is used as a raw steel pipe. The raw steel pipe has an outer diameter of 60.5 mm and a wall thickness of 2.9 mm.

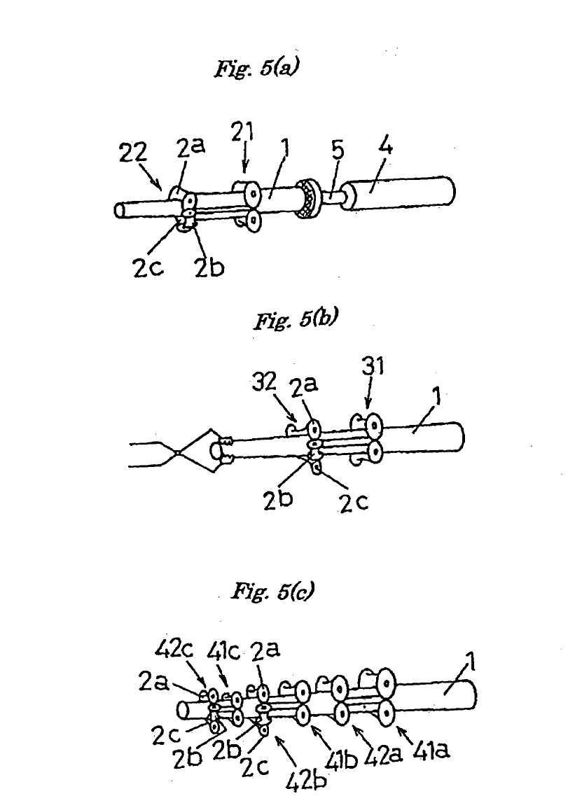

This embodiment uses a process shown in FIG. 5 (b). A diameter reducing process may be performed by passing the raw steel pipe through a set of two pre-forming rolls so that it can be formed into an intermediate steel pipe having an elliptical cross-sectional shape, and then by passing the intermediate steel pipe through a set of two diameter-reducing rolls so that it can be formed into a final steel pipe having a reduction in terms of its diameter. The final steel pipe has an outer diameter of 58.2 mm, which corresponds to a diameter reduction rate of 3.8%.

### Embodiment 4

A steel pipe “STKM13A” (carbon steel pipe for machine structural purposes) as specified in relevant JIS specifications is used as a raw steel pipe. The raw steel pipe has an outer diameter of 63.5 mm and a wall thickness of 1.2 mm.

This embodiment uses the process shown in FIG. 5 (b). A diameter reducing process may be performed by passing the raw steel pipe through a set of two pre-forming rolls so that it can be formed into an intermediate steel pipe having a rectangular cross-sectional shape, and then by passing the intermediate steel pipe through a set of four diameter-reducing rolls so that it can be formed into a final steel pipe having a reduction in terms of its diameter. The final steel pipe has an outer diameter of 60.0 mm, which corresponds to a diameter reduction rate of 5.5%.

### Embodiment 5

A steel pipe “STKM13A” (carbon steel pipe for machine structural purposes) as specified in relevant JIS specifications is used as a raw steel pipe. The raw steel pipe has an outer diameter of 63.5 mm and a wall thickness of 2.3 mm.

This embodiment uses the process shown in FIG. 5 (b). A diameter reducing process may be performed by passing the raw steel pipe through a set of two pre-forming rolls so that it can be formed into an intermediate steel pipe having a rectangular cross-sectional shape, and then by passing the intermediate steel pipe through a set of four diameter-reducing rolls so that it can be formed into a final steel pipe having a reduction in terms of its diameter. The final steel pipe has an outer diameter of 58.2 mm, which corresponds to a diameter reduction rate of 8.3%.

### Embodiment 6

An aluminum pipe “A5052TD” as specified in relevant JIS specifications is used as a raw aluminum pipe. The raw aluminum pipe has an outer diameter of 60.6 mm and a wall thickness of 3.0 mm.

This embodiment uses the process shown in FIG. 5 (b). A diameter reducing process may be performed by passing the raw aluminum pipe through a set of four pre-forming rolls so that it can be formed into an intermediate aluminum pipe having a rectangular cross section, and then by passing the intermediate aluminum pipe through a set of four diameter-reducing rolls so that it can be formed into a final aluminum pipe having a reduction in terms of its diameter. The final aluminum pipe has an outer diameter of 58.2 mm, which corresponds to a diameter reduction rate of 3.0%.

### Embodiment 7

A raw pipe is a double pipe including an outer steel pipe having an outer diameter of 63.5 mm and a wall thickness of 1.2 mm, and an inner steel pipe having an outer diameter of 60.0 mm and a wall thickness of 1.2 mm, with the inner steel pipe being inserted into the outer steel pipe over a total length thereof. The outer and inner steel pipes both use a steel pipe “STK400-E-G” as specified in relevant JIS specifications.

This embodiment uses a process shown in FIG. 5 (a). A diameter reducing process may be performed by passing the raw steel pipe through a set of two pre-forming rolls so that it can be formed into an intermediate steel pipe having an elliptical cross-sectional shape, and then by passing the intermediate steel pipe through a set of two diameter reducing rolls so that it can be formed into a final double-steel pipe having a reduction in terms of its diameter. The final double-steel pipe has an outer diameter of 60.0 mm, which corresponds to a diameter reduction rate of 5.5%.

In the final double-steel pipe thus obtained, the outer and inner steel pipes may be united by causing an inner circumferential wall of the outer steel pipe to engage an outer circumferential wall of the inner steel pipe tightly.

### Embodiment 8

A raw pipe includes an outer steel pipe having an outer diameter of 63.5 mm and a wall thickness of 1.2 mm, and an inner aluminum pipe having an outer diameter of 60.0 mm and a wall thickness of 3.0 mm, with the inner aluminum pipe being inserted into the outer steel pipe over a total length thereof. The outer steel pipe uses a steel pipe “STK400-E-G” as specified in relevant JIS specifications, and the inner aluminum pipe uses an aluminum pipe “A5052TD” as specified in relevant JIS specifications.

This embodiment uses the process shown in FIG. 5 (b). A diameter reducing process may be performed by passing the raw pipe through a set of two pre-forming rolls so that it can be formed into an intermediate pipe having a rectangular cross-sectional shape, and then by passing the intermediate pipe through a set of four diameter reducing rolls so that it can be formed into a final double pipe having a reduction in terms of its diameter. The final double pipe has an outer diameter of 60.0 mm, which corresponds to a diameter reduction rate of 5.5%.

In the final double pipe thus obtained, the outer steel pipe and the inner aluminum pipe may be united by causing an inner circumferential wall of the outer steel pipe to engage an outer circumferential wall of the inner aluminum pipe tightly.

### Embodiment 9

A steel pipe “STKM13A” (carbon steel pipe for machine structural purposes) as specified in relevant JIS specifications is used as a raw steel pipe. The raw steel pipe has an outer diameter of 63.5 mm and a wall thickness of 1.2 mm.

This embodiment uses a process shown in FIG. 5 (c). A diameter reducing process may be performed by using several sets of pre-forming rolls and several sets of diameter reducing rolls. Specifically, the raw steel pipe may first be passed through a first set of two pre-forming rolls so that it can be formed so as to have an elliptical cross-sectional shape. This resulting steel pipe may then be passed through a first set of two diameter reducing rolls so that it can have a reduction in terms of its diameter. This resulting steel pipe may then be passed through a second set of two pre-forming rolls so that it can be formed so as to have an elliptical cross section. This resulting steel pipe may then be passed through a second set of four diameter reducing rolls so that it can have a further reduction in terms of its diameter. This resulting steel pipe may then be passed through a third set of two pre-forming rolls so that it can be formed so as to have an elliptical cross-sectional shape. And, this resulting steel pipe may finally be passed through a third set of four diameter reducing rolls so that it can have a further reduction in terms of its diameter. The final steel pipe has an outer diameter of 56 mm, which corresponds to a diameter reduction rate of 11.8% by utilizing the preceding three sets of the pair of pre-forming rolls and diameter reducing rolls.

### Embodiment 10

A steel pipe “STKM13A” (carbon steel pipe for machine structural purposes) as specified in relevant JIS specifications is used as a raw steel pipe. The raw steel pipe has an outer diameter of 63.5 mm and a wall thickness of 1.6 mm.

This embodiment uses the process shown in FIG. 5 (b). A diameter reducing process may be performed by passing the raw steel pipe through a set of two pre-forming rolls so that it can be formed into an intermediate steel pipe having a triangular cross-sectional shape, and then by passing the intermediate steel pipe through a set of three diameter reducing rolls so that it can have a reduction in terms of its diameter. A final steel pipe thus obtained has an outer diameter of 49 mm, which corresponds to a diameter reduction rate of 22%.

### Embodiment 11

A steel pipe “STKM13A” (carbon steel pipe for machine structural purposes) as specified in relevant JIS specifications is used as a raw steel pipe. The raw steel pipe has an outer diameter of 63.5 mm and a wall thickness of 1.2 mm.

This embodiment uses the process shown in FIG. 5 (b). A diameter reducing process may be performed by passing the raw steel pipe through a set of four pre-forming rolls so that it can be formed into an intermediate steel pipe having a rectangular cross-sectional shape, and then by passing the intermediate steel pipe through a set of four diameter reducing rolls so that it can have a reduction in terms of its diameter. A final steel pipe thus obtained has an outer diameter of 56 mm, which corresponds to a diameter reduction rate of 11.8%.

### Embodiment 12

A steel pipe “STKM13A” (carbon steel pipe for machine structural purposes) as specified in relevant JIS specifications is used as a raw steel pipe. The raw steel pipe has an outer diameter of 63.5 mm and a wall thickness of 1.2 mm.

This embodiment uses the process shown in FIG. 5 (b). A diameter reducing process may be performed by passing the raw steel pipe through a set of five pre-forming rolls so that it can be formed into an intermediate steel pipe having a pentagonal cross-sectional shape, and then by passing the intermediate steel pipe through a set of five diameter reducing rolls so that it can have a reduction in terms of its diameter. A final steel pipe thus obtained has an outer diameter of 58.9 mm, which corresponds to a diameter reduction rate of 7.2%.

### Embodiment 13

A steel pipe “STK400-E-G” (carbon steel pipe for general purposes) as specified in relevant JIS specifications is used as a raw steel pipe. The raw steel pipe has an outer diameter of 190.7 mm and a wall thickness of 4.5 mm.

This embodiment uses the process shown in FIG. 5 (a). A diameter reducing process may be performed by passing the raw steel pipe through a set of two pre-forming rolls so that it can be formed into an intermediate steel pipe having a rectangular cross-sectional shape, and then by passing the intermediate steel pipe through a set of four diameter reducing rolls so that it can have a reduction in terms of its diameter. A final steel pipe thus obtained has an outer diameter of 180 mm, which corresponds to a diameter reduction rate of 5.0%.

### Embodiment 14

A steel pipe “STK400-E-G” (carbon steel pipe for general purposes) as specified in relevant JIS specifications is used as a raw steel pipe. The raw steel pipe has an outer diameter of 216.3 mm and a wall thickness of 10.3 mm.

This embodiment uses the process shown in FIG. 5 (a). A diameter reducing process may be performed by passing the raw steel pipe through a set of four pre-forming rolls so that it can be formed into an intermediate steel pipe having a rectangular cross-sectional shape, and then by passing the intermediate steel pipe through a set of four diameter reducing rolls so that it can have a reduction in terms its diameter. A final steel pipe thus obtained has an outer diameter of 190.7 mm, which corresponds to a diameter reduction rate of 11.0%.

### Embodiment 15

A steel pipe “STK400-E-G” (carbon steel pipe for general purposes) as specified in relevant JIS specifications is used as a raw steel pipe. The raw steel pipe has an outer diameter of 216.3 mm and a wall thickness of 4.5 mm.

This embodiment uses the process shown in FIG. 5 (a). A diameter reducing process may be performed by passing the raw steel pipe through a set of two pre-forming rolls so that it can be formed into an intermediate steel pipe having a rectangular cross-sectional shape, and then by passing the intermediate steel pipe through a set of four diameter reducing rolls, each roll having a pattern of ridges and grooves running in a rotational direction thereof, so that the intermediate steel pipe can have a reduction in terms of its diameter and a pattern of grooves and ridges extending along a length thereof. A final steel pipe thus obtained has an outer diameter of 190.7 mm, which corresponds to a diameter reduction rate of 11.0%, and has a pattern of sixty (60) ridges and grooves formed to a depth of 0.6 mm.

### Embodiment 16

A steel pipe “STK400-E-G” (carbon steel pipe for general purposes) as specified in relevant JIS specifications is used as a raw steel pipe. The raw steel pipe has an outer diameter of 190.7 mm and a wall thickness of 4.5 mm.

This embodiment uses the process shown in FIG. 5 (a). A diameter reducing process may be performed by passing the raw steel pipe through a set of four pre-forming rolls so that it can be formed into an intermediate steel pipe having a rectangular cross-sectional shape, and then by passing the intermediate steel pipe through a set of four diameter reducing rolls, each roll having a pattern of ridges and grooves running in a rotational direction thereof, so that the intermediate steel pipe can have a reduction in terms of its diameter and a pattern of ridges and grooves extending along a length thereof. A final steel pipe thus obtained has an outer diameter of 180 mm, which corresponds to a diameter reduction rate of 5.6%, and has a pattern of sixty (60) ridges and grooves formed to a depth of 0.7 mm.

### CONCLUSION

In all of Embodiments 1 to 16 described above, a raw metal pipe has a circular cross-sectional shape, and a finished metal pipe also has a circular cross-sectional shape. Then, each of these finished metal pipes obtained according to these embodiments was compared with each corresponding raw metal pipe with regard to an outer diameter dimensional precision, and results show that the finished metal pipe has outer diameter dimensional precision that is equivalent to or better than that of the raw metal pipe. Specifically, in Embodiments 1 to 12 where a draw bench process or roll-forming process occurs, the finished metal pipe had an outer diameter dimensional precision that is within ±0.1% of that of the raw metal pipe. In Embodiments 13 to 16 where an extroll-forming process occurs, the finished metal pipe had an outer diameter dimensional precision that is within ±1.0% of that of the raw metal pipe.

After cutting each of the finished metal pipes obtained in Embodiments 1 to 16 to examine its outer diameter, it was found that its outer diameter is substantially the same as that of the finished metal pipe.

The finished metal pipe obtained in any of these embodiments includes some particular areas where the wall thickness is increased during the diameter-reducing process and other areas where the wall thickness remains to be the same as the original wall thickness. Particularly, the wall thickness in those particular areas may be increased as the diameter reduction rate is increased, when the raw metal pipe goes through a most basic arrangement including one set of pre-forming rolls, followed by one set of diameter-reducing rolls. The areas where the wall thickness is increased may be determined by a shape of the pre-forming rolls as well as a shape of the diameter-reducing rolls. Thus, depending upon a particular shape of a final metal pipe that is to be formed, a particular diameter reduction rate that is to be attained, and a particular type of roll-forming that is to be employed, a set of pre-forming rolls having an appropriate shape and the set of diameter-reducing rolls having the appropriate shape may be combined. This allows the final metal pipe to have a uniform wall thickness around an entire circumference thereof when it has its diameter reduced by the cold roll forming method of the present invention.

### INDUSTRIAL APPLICABILITY

According to the various embodiments of the cold roll forming method of the present invention that have been described in detail, a raw metal pipe may be passed through a set of pre-forming rolls so that it can be pre-formed into an intermediate metal pipe having a particular cross-sectional shape, and the intermediate metal pipe may then be passed through a set of diameter-reducing rolls so that it can be re-formed into a circular or any other cross-sectional shape different from a particular shape of the intermediate metal pipe, while at the same time it may have its outer circumferential length reduced to be smaller than an original outer circumferential length of the raw metal pipe.

It may be appreciated from the preceding description that the present invention provides an easy and reliable manner for producing a finished metal pipe having its diameter reduced, or a finished metal pipe having its diameter reduced and having a particular pattern of ridges and grooves formed on either or both of inner and outer circumferential surfaces, or a finished double pipe including inner and outer pipes and having its diameter reduced, without having to increase a number of roll stands used for these purposes.

The cold roll forming methods according to the present invention may be used to produce metal pipes whose wall is thick or partly thick, at less cost and in an easier manner than any of conventional cold roll forming methods.

In the conventional cold roll forming methods that are specifically designed to produce electro-resistance-welded steel pipes and seamless steel pipes, those steel pipes that may be produced by a device that is provided for this purpose should have a particular outer diameter and wall thickness that have previously been determined. In order to produce other such steel pipes that have any other outer diameter and wall thickness than those previously determined, it would be required to modify the existing device or rolls, or otherwise to add another device or rolls so that they can meet particular requirements. This would require an additional cost that leads to a high cost. In contrast, the present invention allows a metal pipe having any desired outer diameter and wall thickness to be produced easily and at low cost, since it requires no additional device or equipment.

When a metal pipe that requires higher strength on any particular part thereof is cold-rolled by a conventional method, the metal pipe is typically cold-rolled by increasing a wall thickness or strength not only on that particular part but also along its total length. In contrast, the present invention allows such metal pipe to be cold-rolled by only using a double pipe on that part requiring higher strength to supplement insufficient strength thereat. This can be achieved at less cost since there is no need of increasing the wall thickness or strength over the total length of the metal pipe, as is the case with the conventional methods.

In this regard, one advantage of the cold roll forming method according to the present invention is that a part of a metal pipe that requires higher strength may be supplemented by a double pipe in which inner and outer pipes may be made to overlap each other on that part by simply aligning the inner pipe with the outer pipe accurately.

In the conventional methods, a part of a metal pipe that requires sufficient strength may be supplemented by using a tailored blank, including a pipe having the same diameter and a different wall thickness, welded to the metal pipe. A further advantage of the present invention is that it allows a double pipe only to be provided on that part of a metal pipe that requires increased wall thickness, without having to use such tailored blank. Thus, this can be achieved at less cost.

When a metal pipe includes portions where a decreased wall thickness may be produced during bending, bulge forming, or hydro-forming of the metal pipe, the present invention allows a double pipe only to be provided on those portions to increase the wall thickness thereat. This can be achieved at less cost and in an easier manner.

According to the present invention, a metal pipe, such as a single pipe and a double pipe, may initially be pre-formed into an intermediate pipe having its diameter reduced, and the intermediate pipe may then be re-formed into a circular, triangular or any other cross-sectional shape. Thus, the present invention provides an easy, reliable and less costly manner for producing multiple-layer steel pipe products having any cross-sectional shape, as compared with prior art methods.

What is claimed is:

1. A cold roll forming method for reducing a diameter of a raw metal pipe, comprising:
passing a raw metal pipe, having an original cross-section, through a set of pre-forming rolls, thereby pre-forming said raw metal pipe into an intermediate metal pipe having one of an elliptical cross-section, elongated circular cross-section, rectangular cross-section, and polygonal cross-section, with the proviso that the cross-section of said intermediate metal pipe is different from the original cross-section in terms of shape; and
passing said intermediate metal pipe through a set of diameter-reducing rolls positioned downstream said set pre-forming rolls, thereby forming said intermediate metal pipe into a pipe member having
(i) an outer circumferential length that is smaller than an outer circumferential length of said raw metal pipe, and
(ii) a cross-section that is different from the cross-section of said intermediate metal pipe in terms of shape.

2. The cold roll forming method according to claim 1, wherein
passing a raw metal pipe through a set of pre-forming rolls comprises passing said raw metal pipe through plural sets of pre-forming rolls, and
passing said intermediate metal pipe through a set of diameter-reducing rolls comprises passing said intermediate metal pipe through plural sets of diameter-reducing rolls,
with at least some of said pre-forming rolls in each of said plural sets of pre-forming rolls and at least some of said diameter-reducing rolls in each of said plural sets of diameter-reducing rolls being rotatably linked with one another, thereby allowing said raw metal pipe to be pulled through said each of said plural sets of pre-forming rolls and allowing said intermediate metal pipe to be pulled through said each of said plural sets of diameter-reducing rolls.

3. The cold roll forming method according to claim 1, wherein
passing a raw metal pipe through a set of pre-forming rolls comprises passing said raw metal pipe through plural sets of pre-forming rolls, and
passing said intermediate metal pipe through a set of diameter-reducing rolls comprises passing said intermediate metal pipe through plural sets of diameter-reducing rolls,
with at least some of said pre-forming rolls in each of said plural sets of pre-forming rolls and at least some of said diameter-reducing rolls in each of said plural sets of diameter-reducing rolls being idler rolls that are free from an external driving force, thereby allowing said raw metal pipe to be moved through said each of said plural sets of pre-forming rolls and allowing said intermediate metal pipe to be moved through said each of said plural sets of diameter-reducing rolls by one of
(i) pushing said raw metal pipe from an upstream side into a bore formed by said pre-forming rolls in said each of said plural sets of pre-forming rolls, and thereby pushing said intermediate metal pipe into a bore formed by said diameter-reducing rolls in said each of said plural sets of diameter-reducing rolls,
(ii) drawing said raw metal pipe toward a downstream side into a bore formed by said pre-forming rolls in said each of said plural sets of pre-forming rolls, and thereby drawing said intermediate metal pipe into a bore formed by said diameter-reducing rolls in said each of said plural sets of diameter-reducing rolls, and
(iii) pushing said raw metal pipe from an upstream side into a bore formed by said pre-forming rolls in said each of said plural sets of pre-forming rolls and thereby pushing said intermediate metal pipe into a bore formed by said diameter-reducing rolls in said each of said plural sets of diameter-reducing rolls, while drawing said raw metal pipe toward a downstream side into said bore formed by said pre-forming rolls in said each of said plural sets of pre-forming rolls and thereby drawing said intermediate metal pipe into said bore formed by said diameter-reducing rolls in said each of said plural sets of diameter-reducing rolls.

4. The cold roll forming method according to claim 1, wherein
each of said diameter-reducing rolls of said set of diameter-reducing rolls has on a surface thereof a pattern of ridges and grooves, such that passing said intermediate metal pipe through said set of diameter-reducing rolls results in said pipe member having the pattern of ridges and grooves formed on a surface thereof.

5. The cold roll forming method according to claim 1, wherein
disposed in a bore formed by said diameter-reducing rolls, of said set of diameter-reducing rolls, is a molding die having on an outer circumferential surface thereof a pattern of ridges and grooves, with said molding die being inserted into said intermediate metal pipe upon passing said intermediate metal pipe through said set of diameter-reducing rolls such that said pipe member has on an inner circumferential surface thereof the pattern of ridges and grooves.

6. The cold roll forming method according to claim 1, wherein
passing said intermediate metal pipe through said set of diameter-reducing rolls results in a diameter of said intermediate metal pipe being reduced by at least 3%.

7. A metal pipe product produced by the method of claim 1.

8. A cold roll forming method for reducing a diameter of a raw metal pipe, comprising:
passing a raw metal pipe, having an original cross-section, through a set of pre-forming rolls, thereby pre-forming said raw metal pipe into an intermediate metal pipe having one of an elliptical cross-section, elongated circular cross-section, rectangular cross-section, and polygonal cross-section, with the proviso that the cross-section of said intermediate metal pipe is different from the original cross-section in terms of shape; and
passing said intermediate metal pipe through a set of diameter-reducing rolls positioned downstream said set pre-forming rolls, thereby forming said intermediate metal pipe into a pipe member having
(i) an outer circumferential length that is smaller than an outer circumferential length of said raw metal pipe, and
(ii) a cross-section that is different from the cross-section of said intermediate metal pipe in terms of shape;
passing said pipe member through another set of pre-forming rolls; and then
passing said pipe member through another set of diameter-reducing rolls.

9. The cold roll forming method according to claim 8, wherein
at least some of said pre-forming rolls in said set of pre-forming rolls and said another set of pre-forming rolls, and at least some of said diameter-reducing rolls in said set of diameter-reducing rolls and said another set of diameter-reducing rolls, are rotatably linked with one another, thereby allowing said raw metal pipe to be pulled through said set of pre-forming rolls, allowing said intermediate metal pipe to be pulled through said set of diameter-reducing rolls, and allowing said pipe member to be pulled through said another set of pre-forming rolls and said another set of diameter-reducing rolls.

10. The cold roll forming method according to claim 8, wherein
at least some of said pre-forming rolls in said set of pre-forming rolls and said another set of pre-forming rolls, and at least some of said diameter-reducing rolls in said set of diameter-reducing rolls and said another set of diameter-reducing rolls, being idler rolls that are free from an external driving force, thereby allowing said raw metal pipe to be moved through said set of pre-forming rolls, allowing said intermediate metal pipe to be moved through said set of diameter-reducing rolls, and allowing said pipe member to be moved through said another set of pre-forming rolls and said another set of diameter-reducing rolls by one of
(i) pushing said raw metal pipe from an upstream side into a bore formed by said pre-forming rolls in said set of pre-forming rolls such that said intermediate metal pipe is pushed into a bore formed by said diameter-reducing rolls in said set of diameter-reducing rolls, and such that said pipe member is pushed into a bore formed by said pre-forming rolls in said another set of pre-forming rolls and into a bore formed by said diameter-reducing rolls in said another set of diameter-reducing rolls,
(ii) drawing said raw metal pipe from a downstream side into a bore formed by said pre-forming rolls in said set of pre-forming rolls such that said intermediate metal pipe is drawn into a bore formed by said diameter-reducing rolls in said set of diameter-reducing rolls, and such that said pipe member is drawn into a bore formed by said pre-forming rolls in said another set of pre-forming rolls and into a bore formed by said diameter-reducing rolls in said another set of diameter-reducing rolls, and
(iii) pushing said raw metal pipe from an upstream side into a bore formed by said pre-forming rolls in said set of pre-forming rolls such that said intermediate metal pipe is pushed into a bore formed by said diameter-reducing rolls in said set of diameter-reducing rolls, and such that said pipe member is pushed into a bore formed by said pre-forming rolls in said another set of pre-forming rolls and into a bore formed by said diameter-reducing rolls in said another set of diameter-reducing rolls, while drawing said raw metal pipe from a downstream side into said bore formed by said pre-forming rolls in said set of pre-forming rolls such that said intermediate metal pipe is drawn into said bore formed by said diameter-reducing rolls in said set of diameter-reducing rolls, and such that said pipe member is drawn into said bore formed by said pre-forming rolls in said another set of pre-forming rolls and into said bore formed by said diameter-reducing rolls in said another set of diameter-reducing rolls.

11. The cold roll forming method according to claim 8, wherein
each of said diameter-reducing rolls, of at least one of said set of diameter-reducing rolls and said another set of diameter-reducing rolls, has on a surface thereof a pattern of ridges and grooves, such that passing said intermediate metal pipe through said set of diameter reducing rolls or passing said pipe member through said another set of diameter-reducing rolls results in said pipe member having the pattern of ridges and grooves formed on a surface thereof.

12. The cold roll forming method according to claim 8, wherein
disposed in a bore formed by said diameter-reducing rolls, of at least one of said set of diameter-reducing rolls and said another set of diameter-reducing rolls, is a molding die having on an outer circumferential surface thereof a pattern of ridges and grooves, with said molding die being inserted into said intermediate metal pipe or said pipe member upon passing said intermediate metal pipe through said set of diameter-reducing rolls or passing said pipe member through said another set of diameter-reducing rolls, such that said pipe member has on an inner circumferential surface thereof the pattern of ridges and grooves.

13. The cold roll forming method according to claim 8, wherein
passing said intermediate metal pipe through said set of diameter-reducing rolls results in a diameter of said intermediate metal pipe being reduced by at least 3%, and
passing said pipe member through said another set of diameter-reducing rolls results in a diameter of said pipe member being reduced by at least 3%.

14. A metal pipe product produced by the method of claim 8.

15. A cold roll forming method for reducing a diameter of a raw metal pipe, comprising:
passing a double pipe, including an original outer metal pipe surrounding an inner metal pipe and having an original diameter, through a set of pre-forming rolls, thereby pre-forming said outer metal pipe into an intermediate outer metal pipe having one of an elliptical cross-section, elongated circular cross-section, rectangular cross-section, and polygonal cross-section, with the proviso that the cross-section of said intermediate outer metal pipe is different from the original cross-section in terms of shape; and then
passing said double pipe through a set of diameter-reducing rolls positioned downstream said set of pre-forming rolls, thereby forming said intermediate outer metal pipe into an outer pipe member having
(i) an outer circumferential length that is smaller than an outer circumferential length of said original outer metal pipe, and
(ii) a cross-section that is different from the cross-section of said intermediate outer metal pipe in terms of shape,
with an inner circumferential surface of said outer pipe member being tightly engaged with an outer circumferential surface of said inner metal pipe.

16. The cold roll forming method according to claim 15, further comprising:
forming said double pipe by inserting said inner metal pipe into said original outer metal pipe such that said inner metal pipe and said original outer metal pipe overlap one another along a total length of said original outer metal pipe.

17. The cold roll forming method according to claim 15, wherein
passing a double pipe through a set of pre-forming rolls comprises passing said double pipe through plural sets of pre-forming rolls, and
passing said double pipe through a set of diameter-reducing rolls comprises passing said double pipe through plural sets of diameter-reducing rolls,
with at least some of said pre-forming rolls in each of said plural sets of pre-forming rolls and at least some of said diameter-reducing rolls in each of said plural sets of diameter-reducing rolls being rotatably linked with one another, thereby allowing said double pipe to be pulled through said each of said plural sets of pre-forming rolls and allowing said double pipe to be pulled through said each of said plural sets of diameter-reducing rolls.

18. The cold roll forming method according to claim 15, wherein
passing a double pipe through a set of pre-forming rolls comprises passing said double pipe through plural sets of pre-forming rolls, and
passing said double pipe through a set of diameter-reducing rolls comprises passing said double pipe through plural sets of diameter-reducing rolls,
with at least some of said pre-forming rolls in each of said plural sets of pre-forming rolls and at least some of said diameter-reducing rolls in each of said plural sets of diameter-reducing rolls being idler rolls that are free from an external driving force, thereby allowing said double pipe to be moved through said each of said plural sets of pre-forming rolls and allowing said double pipe to be moved through said each of said plural sets of diameter-reducing rolls by one of
(i) pushing said double pipe from an upstream side into a bore formed by said pre-forming rolls in said each of said plural sets and into a bore formed by said diameter-reducing rolls in said each of said plural sets of diameter-reducing rolls,
(ii) drawing said double pipe toward a downstream side into a bore formed by said pre-forming rolls in said each of said plural sets of pre-forming rolls and into a bore formed by said diameter-reducing rolls in said each of said plural sets of diameter-reducing rolls, and
(iii) pushing said double pipe from an upstream side into a bore formed by said pre-forming rolls in said each of said plural sets of pre-forming rolls and into a bore formed by said diameter-reducing rolls in said each of said plural sets of diameter-reducing rolls, while drawing said double pipe toward a downstream side into said bore formed by said pre-forming rolls in said each of said plural sets of pre-forming rolls and into said bore formed by said diameter-reducing rolls in said each of said plural sets of diameter-reducing rolls.

19. The cold roll forming method according to claim 15, wherein
each of said diameter-reducing rolls of said set of diameter-reducing rolls has on a surface thereof a pattern of ridges and grooves, such that passing said double pipe through said set of diameter-reducing rolls results in said outer pipe member having the pattern of ridges and grooves formed on a surface thereof.

20. The cold roll forming method according to claim 15, wherein
passing said double pipe through said set of diameter-reducing rolls results in a diameter of said intermediate outer metal pipe being reduced by at least 3%.

21. A metal pipe product produced by the method of claim 15.

22. A cold roll forming method for reducing a diameter of a raw metal pipe, comprising:
passing a double pipe, including an original outer metal pipe surrounding an inner metal pipe and having an original diameter, through a set of pre-forming rolls, thereby pre-forming said outer metal pipe into an intermediate outer metal pipe having one of an elliptical cross-section, elongated circular cross-section, rectangular cross-section, and polygonal cross-section, with the proviso that the cross-section of said intermediate outer metal pipe is different from the original cross-section in terms of shape; then
passing said double pipe through a set of diameter-reducing rolls positioned downstream said set pre-forming rolls, thereby forming said intermediate outer metal pipe into an outer pipe member having
(i) an outer circumferential length that is smaller than an outer circumferential length of said original outer metal pipe, and
(ii) a cross-section that is different from the cross-section of said intermediate outer metal pipe in terms of shape; then
passing said double pipe through another set of pre-forming rolls; and then
passing said double pipe through another set of diameter-reducing rolls,
whereby an inner circumferential surface of said outer pipe member is tightly engaged with an outer circumferential surface of said inner metal pipe.

23. The cold roll forming method according to claim 22, further comprising:
forming said double pipe by inserting said inner metal pipe into said original outer metal pipe such that said inner metal pipe and said original outer metal pipe overlap one another along a total length of said original outer metal pipe.

24. The cold roll forming method according to claim 22, wherein
at least some of said pre-forming rolls in said set of pre-forming rolls and said another set of pre-forming rolls, and at least some of said diameter-reducing rolls in said set of diameter-reducing rolls and said another set of diameter-reducing rolls, are rotatably linked with one another, thereby allowing said double pipe to be pulled through said set of pre-forming rolls, allowing said double pipe to be pulled through said set of diameter-reducing rolls, and allowing said double pipe to be pulled through said another set of pre-forming rolls and said another set of diameter-reducing rolls.

25. The cold roll forming method according to claim 22, wherein
at least some of said pre-forming rolls in said set of pre-forming rolls and said another set of pre-forming rolls, and at least some of said diameter-reducing rolls in said set of diameter-reducing rolls and said another set of diameter-reducing rolls, being idler rolls that are free from an external driving force, thereby allowing said double pipe to be moved through said set of pre-forming rolls, allowing said double pipe to be moved through said set of diameter-reducing rolls, and allowing said double pipe to be moved through said another set of pre-forming rolls and said another set of diameter-reducing rolls by one of
(i) pushing said double pipe from an upstream side into a bore formed by said pre-forming rolls in said set of pre-forming rolls, into a bore formed by said diameter-reducing rolls in said set of diameter-reducing rolls, into a bore formed by said pre-forming rolls in said another set of pre-forming rolls and into a bore formed by said diameter-reducing rolls in said another set of diameter-reducing rolls,
(ii) drawing said double pipe from a downstream side into a bore formed by said pre-forming rolls in said set of pre-forming rolls, into a bore formed by said diameter-reducing rolls in said set of diameter-reducing rolls, into a bore formed by said pre-forming rolls in said another set of pre-forming rolls and into a bore formed by said diameter-reducing rolls in said another set of diameter-reducing rolls, and
(iii) pushing said double pipe from an upstream side into a bore formed by said pre-forming rolls in said set of pre-forming rolls, into a bore formed by said diameter-reducing rolls in said set of diameter-reducing rolls, into a bore formed by said pre-forming rolls in said another set of pre-forming rolls and into a bore formed by said diameter-reducing rolls in said another set of diameter-reducing rolls, while drawing said double pipe from a downstream side into said bore formed by said pre-forming rolls in said set of pre-forming rolls, into said bore formed by said diameter-reducing rolls in said set of diameter-reducing rolls, into said bore formed by said pre-forming rolls in said another set of pre-forming rolls and into said bore formed by said diameter-reducing rolls in said another set of diameter-reducing rolls.

26. The cold roll forming method according to claim 22, wherein
each of said diameter-reducing rolls, of at least one of said set of diameter-reducing rolls and said another set of diameter-reducing rolls, has on a surface thereof a pattern of ridges and grooves, such that passing said double pipe through said set of diameter reducing rolls or passing said double pipe through said another set of diameter-reducing rolls results in said outer pipe member having the pattern of ridges and grooves formed on a surface thereof.

27. The cold roll forming method according to claim 22, wherein
passing said double pipe through said set of diameter-reducing rolls results in a diameter of said outer metal pipe being reduced by at least 3%, and
passing said double pipe through said another set of diameter-reducing rolls results in a diameter of said outer pipe member being reduced by at least 3%.

28. A metal pipe product produced by the method of claim 22.

29. The cold roll forming method according to claim 1, wherein
said raw material pipe has a wall thickness within a range of from 1.6 mm to 10.3 mm.

30. The cold roll forming method according to claim 8, wherein
said raw material pipe has a wall thickness within a range of from 1.6 mm to 10.3 mm.

31. The cold roll forming method according to claim 15, wherein
said double pipe has a double wall thickness equal to a wall thickness of said original outer metal pipe plus a wall thickness of said inner metal pipe, with said double wall thickness being within a range of from 1.6 mm to 10.3 mm.

32. The cold roll forming method according to claim 22, wherein
said double pipe has a double wall thickness equal to a wall thickness of said original outer metal pipe plus a wall thickness of said inner metal pipe, with said double wall thickness being within a range of from 1.6 mm to 10.3 mm.

33. The cold roll forming method according to claim 1, wherein
said raw metal pipe has a wall thickness and a diameter, with a ratio of said diameter to said wall thickness being within a range of from 20.0 to 52.9, and
passing said intermediate metal pipe through said set of diameter-reducing rolls results in a diameter of said intermediate metal pipe being reduced by 3%-22%.

34. The cold roll forming method according to claim 8, wherein
said raw metal pipe has a wall thickness and a diameter, with a ratio of said diameter to said wall thickness being within a range of from 20.0 to 52.9,
passing said intermediate metal pipe through said set of diameter-reducing rolls results in a diameter of said intermediate metal pipe being reduced by 3%-22%, and
passing said pipe member through said another set of diameter-reducing rolls results in a diameter of said pipe member being reduced by 3%-22%,
with the proviso that total diameter reduction does not exceed 22%.

35. The cold roll forming method according to claim 15, wherein
said double pipe has a double wall thickness equal to a wall thickness of said original outer metal pipe plus a wall thickness of said inner metal pipe, and said original outer metal pipe has a diameter, with a ratio of said diameter to said double wall thickness being within a range of from 20.0 to 52.9, and
passing said double pipe through said set of diameter-reducing rolls results in a diameter of said intermediate outer metal pipe being reduced by 3%-22%.

36. The cold roll forming method according to claim 22, wherein
said double pipe has a double wall thickness equal to a wall thickness of said original outer metal pipe plus a wall thickness of said inner metal pipe, and said original outer metal pipe has a diameter, with a ratio of said diameter to said double wall thickness being within a range of from 20.0 to 52.9,
passing said double pipe through said set of diameter-reducing rolls results in a diameter of said intermediate outer metal pipe being reduced by 3%-22%, and
passing said double pipe through said another set of diameter-reducing rolls results in a diameter of said outer pipe member being reduced by 3%-22%,
with the proviso that total diameter reduction does not exceed 22%.

37. A cold roll forming method for reducing a diameter of a raw metal pipe, comprising:
passing a raw metal pipe, having an original cross-section, through plural sets of pre-forming rolls, thereby pre-forming said raw metal pipe into an intermediate metal pipe having one of an elliptical cross-section, elongated circular cross-section, rectangular cross-section, and polygonal cross-section, with the proviso that the cross-section of said intermediate metal pipe is different from the original cross-section in terms of shape; and
passing said intermediate metal pipe through plural sets of diameter-reducing rolls positioned downstream said plural sets of pre-forming rolls, thereby forming said intermediate metal pipe into a pipe member having
(i) an outer circumferential length that is smaller than an outer circumferential length of said raw metal pipe, and
(ii) a cross-section that is different from the cross-section of said intermediate metal pipe in terms of shape.

38. The cold roll forming method according to claim 37, wherein
each of said diameter-reducing rolls of at least one of said plural sets of diameter-reducing rolls has on a surface thereof a pattern of ridges and grooves, such that passing said intermediate metal pipe through said plural sets of diameter-reducing rolls results in said pipe member having the pattern of ridges and grooves formed on a surface thereof.

39. The cold roll forming method according to claim 37, wherein
disposed in a bore formed by said diameter-reducing rolls, of at least one of said plural sets of diameter-reducing rolls, is a molding die having on an outer circumferential surface thereof a pattern of ridges and grooves, with said molding die being inserted into said intermediate metal pipe upon passing said intermediate metal pipe through said plural sets of diameter-reducing rolls such that said pipe member has on an inner circumferential surface thereof the pattern of ridges and grooves.

40. The cold roll forming method according to claim 37, wherein
passing said intermediate metal pipe through said plural sets of diameter-reducing rolls results in a diameter of said intermediate metal pipe being reduced by at least 3%.

41. A metal pipe product produced by the method of claim 37.

42. A cold roll forming method for reducing a diameter of a raw metal pipe, comprising:
passing a double pipe, including an original outer metal pipe surrounding an inner metal pipe and having an original diameter, through plural sets of pre-forming rolls, thereby pre-forming said outer metal pipe into an intermediate outer metal pipe having one of an elliptical cross-section, elongated circular cross-section, rectangular cross-section, and polygonal cross-section, with the proviso that the cross-section of said intermediate outer metal pipe is different from the original cross-section in terms of shape; and then
passing said double pipe through plural sets of diameter-reducing rolls positioned downstream said plural sets of pre-forming rolls, thereby forming said intermediate outer metal pipe into an outer pipe member having
(i) an outer circumferential length that is smaller than an outer circumferential length of said original outer metal pipe, and
(ii) a cross-section that is different from the cross-section of said intermediate outer metal pipe in terms of shape,
with an inner circumferential surface of said outer pipe member being tightly engaged with an outer circumferential surface of said inner metal pipe.

43. The cold roll forming method according to claim 42, further comprising:
forming said double pipe by inserting said inner metal pipe into said original outer metal pipe such that said inner metal pipe and said original outer metal pipe overlap one another along a total length of said original outer metal pipe.

44. The cold roll forming method according to claim 42, wherein
each of said diameter-reducing rolls of at least one of said plural sets of diameter-reducing rolls has on a surface thereof a pattern of ridges and grooves, such that passing said double pipe through said plural sets of diameter-reducing rolls results in said outer pipe member having the pattern of ridges and grooves formed on a surface thereof.

45. The cold roll forming method according to claim 42, wherein
passing said double pipe through said plural sets of diameter-reducing rolls results in a diameter of said intermediate outer metal pipe being reduced by at least 3%.

46. A metal pipe product produced by the method of claim 42.

47. The cold roll forming method according to claim 37, wherein
said raw material pipe has a wall thickness within a range of from 1.6 mm to 10.3 mm.

48. The cold roll forming method according to claim 37, wherein
said raw metal pipe has a wall thickness and a diameter, with a ratio of said diameter to said wall thickness being within a range of from 20.0 to 52.9, and
passing said intermediate metal pipe through said plural sets of diameter-reducing rolls results in a diameter of said intermediate metal pipe being reduced by 3%-22%.

49. The cold roll forming method according to claim 42, wherein
said double pipe has a double wall thickness equal to a wall thickness of said original outer metal pipe plus a wall thickness of said inner metal pipe, with said double wall thickness being within a range of from 1.6 mm to 10.3 mm.

50. The cold roll forming method according to claim 42, wherein
said double pipe has a double wall thickness equal to a wall thickness of said original outer metal pipe plus a wall thickness of said inner metal pipe, and said original outer metal pipe has a diameter, with a ratio of said diameter to said double wall thickness being within a range of from 20.0 to 52.9, and
passing said double pipe through said plural sets of diameter-reducing rolls results in a diameter of said intermediate outer metal pipe being reduced by 3%-22%.
